(19) United States
(12) Patent Application Publication
(10) Pub. No.: US 2016/0339299 A1
(43) Pub. Date: Nov. 24, 2016

(54) INTEGRATED IMPAIRMENT VALUE CALCULATION SYSTEM

(71) Applicants: Donald B. Gronachan, Holtsville, NY (US); Larry Lemberger, Whitelaw, WI (US)

(72) Inventors: Donald B. Gronachan, Holtsville, NY (US); Larry Lemberger, Whitelaw, WI (US)

(21) Appl. No.: 14/717,370

(22) Filed: May 20, 2015

(51) Int. Cl. A63B 24/00; A63B 22/02; G06F 19/00; A63B 26/00

(52) U.S. Cl. CPC A63B 24/0062; A63B 26/003; A63B 22/02; G06F 19/3443

(57) ABSTRACT

System and method for converting testing and/or performance data on a therapeutic or testing device to a percentile impairment score, as used in G-Codes required by Medicaid, using an algorithm or formula, and optionally calculating and/or storing algorithm or formula used for conversion on a server. System and method is integrated into a therapeutic or testing device for easy and reliable use by operators and/or users.

### FIELD OF THE INVENTION

The present invention relates to testing devices, particularly those used to evaluate and/or test physical therapy patients. The present invention further relates to systems, software and methods for calculating a patient's impairment on a numeric scale and for maintaining and updating a database of patient evaluation values.

### BACKGROUND OF THE INVENTION

Doctors, physical therapists, medical technicians and others engaged in physical therapy, kinesiology and other related fields conventionally use a variety of testing devices to assess the ability and/or difficulties of patients. Such testing devices generally report a set of numerical values based on the patient's performance on certain evaluative tasks. For example, a balance trainer, which is a combination testing and physical therapy device, reports values including a patient's weight distribution and stability, while the patient attempts to stand upright on different surfaces and with their eyes open or closed. The numerical values reported on different tests may have different units and be on different scales. Furthermore, on some tests, a low value is considered a good result and on other tests a high value is considered a good result. Accordingly, in many cases, there is no easy way to compare the values reported by different testing devices or by the same device on different tasks without familiarity with each task on each testing device.

Recent statutory changes in the Medicare law introduced the requirement that therapy providers collect data on patient function during the course of therapy services. The Center for Medicare and Medicaid Services (“CMS”), to implement this new requirement, introduced G-Codes. Each G-Code indicates three parameters: (i) a capability or set of capabilities, e.g. mobility; swallowing; self-care or carrying, moving & handling objects; (ii) the stage of treatment, i.e. current status, goal or at discharge; and (iii) a percentage impairment score. For example, G-Code G8981 CL indicates a patient is currently between 60% and 79% (CL) impaired in changing and maintaining body position (G8981). As a further example, G-Code G8989 CM indicates a patient was discharged between 80% and 99% (CM) impaired in self-care (G8989), i.e., that the patient only had between 1% and 20% of the normal ability to care for theirself. As a result of these new regulations, there is a need for therapy providers to quickly, reliably and reproducibly assign a percentage impairment value to a patient receiving therapy.

However, because the testing values assigned by testing devices to a patient's performance do not directly assess the patient's impairment, it is often left to the therapist or technician to assign a percentage impairment value to a non-percentage or even non-numeric testing value produced by a particular task on a particular testing machine. As a result, such percentage impairment values are unreliable, subjective and vary among technicians. Such variance can make accurately tracking therapeutic progress and success more difficult.

Various inventions in the field attempt to automatically assign medical coding and/or insurance coding to patients. For example, U.S. Pat. No. 8,560,350 is directed to a computer method and system for generation insurance bills that include optimized insurance coding. This system produces insurance bills for chemotherapy and related services to maximize reimbursement for treatment.

Other inventions assess reported impairment values. For example, U.S. Pat. No. 8,185,410 discloses a method of verifying a permanent medical impairment numeric rating by statistically comparing it to the impairment numeric rating reported for other patients with the same medical diagnosis.

However, a system or method for converting test values to a percentile impairment rating based on statistical data is not known in the art. Such a system would allow for the reliable and accurate conversion of test values and/or results to percentile impairment ratings. The present invention is such a system.

### SUMMARY OF THE INVENTION

The present invention is an integrated system and method for obtaining values derived from the results of physical therapy and/or testing procedures using physical therapy devices and/or testing devices and converting these values into percentile impairment values. In one embodiment, the system collects test data of a patient, evaluates the test data and converts test values to percentile impairment values using a constant conversion value. In another embodiment, the system collects test data of a patient, evaluates the test data and converts testing values to percentile impairment values using statistical methods, with tolerances adjustable by an operator. In a third, preferred, embodiment, the system collects test data of a patient, evaluates the test data and converts test values to percentile impairment values using statistical methods based on patient population data collected by multiple and/or a network of physical therapy devices and/or testing devices. The data is used to update a dynamic population model of normal test values. That is, in this embodiment the database of test values is self-propagated and normalized. In any of the embodiments, the system may also transmit test data to a central database of patient population data.

As used herein, physical therapy devices and/or testing devices include any machine, device and/or apparatus used in a physical therapy patient's therapy or to test a physical therapy patient and produce a rating, value, score, result and/or evaluation based on the patient's performance on a test, at a task or during therapy. Such ratings, values, scores, results and/or evaluations based on the patient's performance on a test, at a task or during therapy are referred to herein as numeric assessments. Examples of physical therapy devices and/or testing devices include, without restriction, gait trainers, balance trainers, strength testers and strength trainers. Physical therapy devices and/or testing devices may be referred to as “therapy devices” herein. Therapy devices often include motorized systems to control position, provide resistance or challenge the capabilities of patients. Therapy devices often also include electronic systems to control their operation and/or provide output regarding performance and/or testing.

As used herein, a patient is a person receiving physical therapy, being evaluated for physical therapy or who has completed physical therapy and is evaluated using a therapy device. An operator is a doctor, therapist, technician, nurse or other person who operates the therapy device to evaluate, test, diagnose, provide therapy to, assess or otherwise assist a patient.

In a first embodiment of the invention, a testing device includes a therapy device and an integrated conversion system for generating a percentile impairment rating using a linear arithmetic conversion from testing results. When a patient uses said therapy device, the testing device outputs a numeric assessment of the patient's performance. The integrated conversion system converts that output into a percentile impairment rating by multiplying a component of the numeric assessment by a fixed value and outputs the result of that multiplication.

In a second embodiment of the invention, a testing device includes a therapy device and an integrated conversion system for generating a percentile impairment rating using analysis of testing results. The integrated conversion system includes a memory and said memory stores algorithms for conversion of numeric assessments for each task the therapy device can assess. Such algorithms can include, without restriction, statistical data on average numeric assessments, linear constants, pre-defined value ranges, and operator-defined value ranges. The algorithms may be updated or selected by an operator or by a central server.

A third embodiment includes the therapy device and integrated conversion system of the second embodiment. The integrated conversion system can communicate with a patient data server to transmit patient data, including, without restriction, age, gender and numeric assessments. The patient data server may be the same server as the central server or may be separate. In this embodiment, the data from multiple patients is used to create and update a database of normalized test values. The normalized test values are then used to generate or update algorithms for conversion of numeric assessments for each task each therapy device can assess, as in the previous embodiment. This provides the most statistically accurate and most current conversions possible, which produce the most accurate and informative percentile impairment scores possible, which can then be integrated into G-Codes. The updated database also allows statistical analysis of patient data to recognize trends in patient health and thereby improve physical therapy techniques and treatment.

### BRIEF DESCRIPTION OF THE DRAWINGS

FIG. 1 is a block diagram depicting the therapy device and integrated conversion system of the invention;

FIG. 2 is a block diagram depicting an embodiment of the invention including connections to one or more servers;

FIG. 3 is a block diagram depicting the function of an embodiment of the invention connected to one or more servers; and

FIG. 4 is an illustration of a gait trainer embodiment of the invention.

### DETAILED DESCRIPTION OF THE INVENTION

The present invention is an integrated system for converting test values obtained as the results of physical therapy and/or testing procedures performed using physical therapy devices and/or testing devices into percentile impairment values and a method of use of said system. The percentile impairment values are those used in G-Codes to indicate patient status before, during and after physical therapy. The present invention may also include a database and/or databases of conversion algorithms and/or patient data collected from physical therapy devices and/or testing devices.

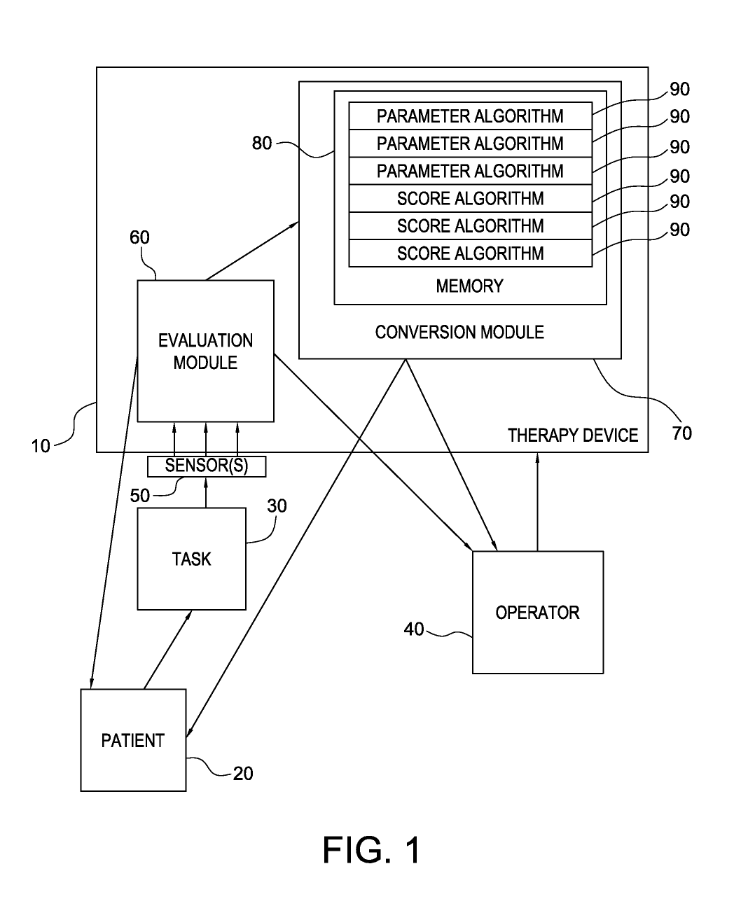

Referring to FIG. 1, a therapy device 10 is used to evaluate, test or provide therapy to a patient 20. The therapy device 10 has one or more sensor(s) 50, each capable of measuring data in one or more parameters. Sensor(s) 50 may be, without restriction, weight sensors, pressure sensors, optical sensors or accelerometers. The patient 20 performs a task 30 that is measured by the sensor(s) 50. The task 30 may be a therapeutic task, in which the performance of the task provides therapeutic benefits to the patient 20, or a testing task, in which the performance of the task permits evaluation of the patient 20 but does not provide therapeutic benefits. The task 30 may be performed on or using the therapy device 10 or the therapy device 10 may only collect data on the patient's 20 performance of the task 30. Therapy device 10 may be capable of collecting data from only one type of task 30 or from a variety of tasks. Sensor(s) 50 may each measure one parameter per task 30 or more than one parameter pre task 30. Not all sensor(s) 50 are always used for each task 30 that can be measured by a therapy device 10. Task 30 may be, without restriction, strength training, balance measurement, walking on a treadmill, or attempting to balance on an uneven surface. One or more operator(s) 40 control the therapy device 10 as required for performance of the task. The operator 40 may also provide therapy to the patient 10 or may be the patient 10.

The patient's 20 performance of the task 30 on one or more parameters is recorded by the sensor(s) 50 as data in each parameter. Parameters can include, without restriction, weight, speed, weight distribution, time between steps, or any other measurable aspect of the patient 20 or the patient's 20 performance on the task 30. The data in the parameters for a single patient 20 is that patient's 20 patient data 35. The sensor(s) 50 transmit the recorded patient data 35 to an evaluation module 60. The evaluation module 60 is configured to calculate one or more numeric scores on one or more scales using patient data 35; output patient data 35 and/or said one or more numeric scores to the operator 40 and/or patient 20; and/or transmit t patient data 35 and/or said one or more numeric scores to a conversion module 70.

The conversion module 70 includes a memory 80, said memory 80 containing one or more algorithms 90. The memory may further contain statistical patient population data and/or data regarding normal values for parameters measured by sensors 50 and/or scores calculated by evaluation module 60. Said statistical patient population data and/or data regarding normal values may be permanently or semi-permanently stored in said memory 80 or may be stored in memory 80 after being transmitted to conversion module 70 by evaluation module 60 and/or an external source. Each algorithm 90 is a mathematical algorithm for patient data 35 or a numeric score to a percentile impairment value. Algorithm 90 can be any algorithm or formula, including, without restriction, statistical formulae and/or proprietary formulae. Patient data 35 and/or numeric score(s) transmitted by the evaluation module 60 to the conversion module 70 is converted by one or more algorithms 90 specific to the parameter of the patient data 35 or numeric score into a percentile impairment score. The conversion module 70 outputs the percentile impairment scores that result from the conversion to operator 40 and/or patient 20.

Algorithm 90 may be any algorithm for converting a specific parameter from patient data 35 or numeric score to a percentile impairment value. An example of an algorithm 90, without restriction, is an algorithm that assigns (i) a percentile impairment score of 0% to a parameter or numeric score within one standard deviation of the statistical mean for that parameter or numeric score; (ii) a percentile impairment score of 100% to a parameter or numeric score at or outside three standard deviations from the statistical mean for that parameter or numeric score; and (iii) assigns a percentile impairment scores to a parameter or numeric score between one and three standard deviations from the statistical mean for that parameter or numeric score based on a linear scale from the value at one standard deviation from the statistical mean and three standard deviations from the statistical mean. Using this example algorithm 90 for a test where the statistical mean for numeric scores is 20, scores between 20 and 30 are within one standard deviation from the statistical mean and scores of 80 or greater are three standard deviations from the statistical mean, scores below 30 would be assigned a percentile impairment score of 0%, scores of 80 or above would be assigned a percentile impairment score of 100% and scores between 30 and 80 would be assigned percentile impairment scores on a linear scale, for example, where a score of 40 would be assigned a percentile impairment score of 20%, a score of 50 would be assigned a percentile impairment score of 30% and so on. Other algorithms 90 are contemplated by the invention, and the example algorithm 90 presented herein does not restrict the scope of the invention.

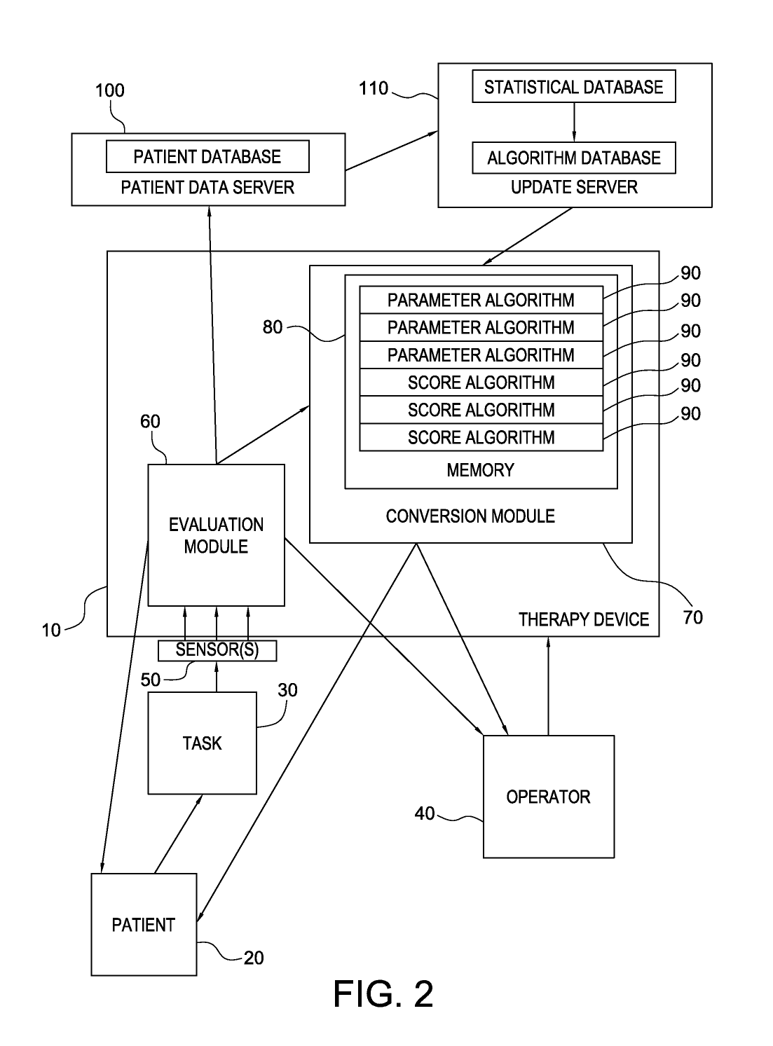

Turning to FIG. 2, in another embodiment of the invention, the therapy device 10 is capable of communication with remote servers 100, 110. Evaluation module 60 is configured to transmit patient data 35 and/or one or more patient numeric scores and/or patient data input by patient 20 and/or operator 40 to a patient data server 100. The transmission of patient data 35 may be, without restriction, by the internet, over a private network, by cellular or other form of radio or wireless communication, by transfer of physical memory media and/or by hardwired connection if necessary. The transmission of patient data 35 can occur automatically whenever patient data 35 is received by the evaluation module 60, a patient numeric score is calculated by the evaluation module, on a set schedule or when directed by a patient 20 or operator 40. Additionally, conversion module 70 is configured to receive and/or employ algorithms 90 and/or statistical data from an update server 110. The reception of algorithms 90 and/or statistical data may be, without restriction, by the internet, over a private network, by cellular or other form of radio or wireless communication, by transfer of physical memory media and/or by hardwired connection if necessary. The reception of algorithms 90 and/or statistical data can occur automatically whenever patient data 35 and/or numeric scores are received by the conversion module 70, on a set schedule or when directed by a patient 20 or operator 40.

Patient data server 100 and update server 110 may be the same server, co-located servers, or may be housed and operated separately. Patient data server 100 includes a patient database 120. Update server 110 includes a statistical database 130 and an algorithm database 140. In other embodiments, the statistical database 130 may be stored on the patient data server 100 or integrated with the algorithm database 140. Each database 100, 130 and 140 may be located on either server 100 and 110 or may be located on individual servers that interoperate. The information stored in the statistical database 130 may be calculated by a statistical analysis system 150 using the patient data 35 stored in the patient database 120 or may be input by a user based on criteria selected by said user. The statistical analysis system 150 may be integrated into the patient data server 100, may be integrated into the update server 110, may operate independently or may be conducted by a user. The information stored in the algorithm database 140 may be calculated by an algorithm assignment system 160 or may be input by a user based on criteria selected by said user. The algorithm assignment system 160 may be integrated into the patient data server 100, the update server 110, independently operating or may be conducted by a user.

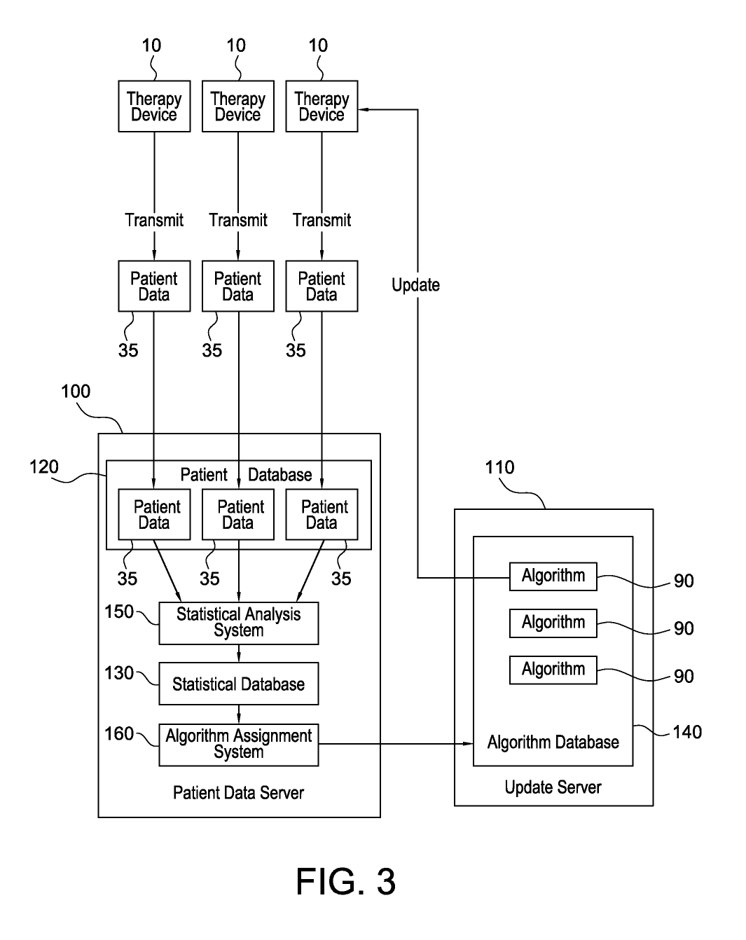

FIG. 3 illustrates the interoperation of the therapy device 10, the patient data server 100 and the update server 110. Patient data 35 collected by a plurality of therapy device(s) 10 is transmitted to the patient data server 100, where it is stored in the patient database 120. The patient data 35 in the patient database 120 undergoes statistical analysis using the statistical analysis system 150 to create statistical and/or normative data regarding the population of patients 20 who receive therapy or are evaluated using therapy device(s) 10. The statistical and/or normative data is stored in statistical database 130. The statistical and/or normative data stored in statistical database 130 is processed using the algorithm assignment system 160 to produce algorithms. The algorithms are stored in algorithm database 140. When a therapy device 10 connects to the update server 110, the update server 110 transmits the most recently produced algorithms for use on a therapy device 10 of the type connected to the update server 110 to said therapy device 10. A therapy device 10 may connect to the update server 110 on a schedule, at a time initiated by a user or it may be continuously connected. Said therapy device 10 then replaces any algorithm(s) 90 in its memory 80 that are older than the algorithms transmitted by the update server 110.

As an exemplar embodiment, a gait trainer is further described in accordance with the invention. This description does not restrict the scope of the invention to gait trainers, the parameters and/or data measured by gait trainers and/or the particular statistical methods described. The invention should be understood to encompass all embodiments in accordance with the foregoing description.

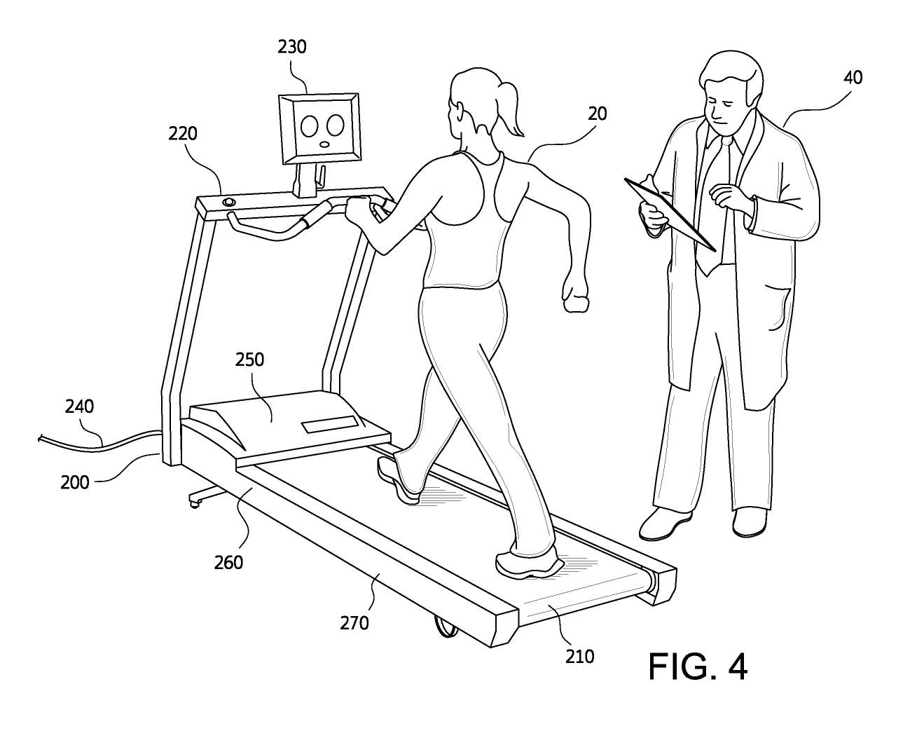

Referring to FIG. 4, a gait trainer 200 is a type of therapy device 10. Said gait trainer includes a motorized treadmill 210 that can vary both speed and, optionally, incline, sensors 50, controls 220, a display 230, an evaluation module 60 as described above, a conversion module 70 as described above and a communication means 240. Sensors 50 include, without restriction, a speed sensor 250, an incline sensor 260, and a step detector 270. The operator and/or patient can activate the treadmill 210, deactivate the treadmill 210, control the treadmill speed and control the treadmill incline using the controls 220. The patient 20 may use the gait trainer 200 for therapeutic purposes or to determine the extent of the patient's 20 impairment.

A patient 20 uses the gait trainer 200 by walking on the treadmill 210 when it is turned on using the controls 220. While the patient 20 walks, the speed sensor 250 measures the patient's 20 walking speed, the incline sensor 260 measures the incline of the treadmill 210 and the step detector 270 measures the patient's 20 step time, time on each foot and stride length. The sensors 250, 260, 270 transmit the measured data to the evaluation module 60. The evaluation module 60 processes the measured data into session data by averaging the data in each parameter. The evaluation module outputs the session data to display 230, transmits the session data to conversion module 70 and transmits the session data to the patient data server 100. The evaluation module 60 may calculate, output and transmit the session data, without restriction, on a continuous basis, at the end of a session or when the operator 40 or patient 20 cause the evaluation module 60 to do so. Each output and transmission of the session data may occur based on a different criteria or on a particular schedule. The conversion module 70 contains, in memory 80, at least one algorithm 90 for converting session data to percentile impairment values. Each parameter has an associated algorithm 90, that is, a first algorithm 90 converts session data for step time to a percentile impairment value, a second algorithm 90 converts session data for walking speed to a percentile impairment value and so on for each measured parameter. The conversion module 70 performs each algorithm 90 on its associated measured parameter and outputs the resulting impairment value to display 230. Additionally, a composite value algorithm 90 converts data from multiple parameters into a composite impairment value. Different composite value algorithms 90 convert data from different pairs or groups of parameters, that is, a first composite value algorithm converts session data for walking speed and step time into a single percentile impairment value, a second composite value algorithm converts session data for walking speed and incline into a single percentile impairment value and so on for any number of pairs or groups of parameters.

While the foregoing description and drawings represent the preferred embodiments of the present invention, it will be understood that various changes and modifications may be made without departing from the scope of the present invention.

I claim:

1. A system for calculating and displaying a percentile impairment value for a patient, comprising:
a testing device having one or more sensors, each of said sensors being configured to measure a parameter of the patient;
a conversion computer connected to the testing device, configured to receive at least one measured parameter value of the patient from at least one of said sensors, and having at least one algorithm for calculating a percentile impairment score from the received at least one measured parameter value of the patient; and
a display connected to the conversion computer and configured to receive output relating to the calculated percentile impairment score from the conversion computer and display the output.

2. The system of claim 1, further comprising a memory coupled to said conversion computer and that stores the at least one algorithm.

3. The system of claim 2, further comprising an algorithm database connected to said conversion computer, said algorithm database having a memory and storing in said memory at least one library algorithm for calculating the percentile impairment score from a measured parameter value of the patient, wherein said conversion computer is configured to copy one or more library algorithms for calculating the percentile impairment score from a measured parameter value of the patient and store said one or more library algorithms in the memory of said conversion computer.

4. The system of claim 3, wherein the conversion computer is configured to connect to the algorithm database via the internet.

5. The system of claim 1, wherein the testing device is a gait trainer

6. The system of claim 1, wherein the testing device is a balance trainer.

7. The system of claim 1, wherein said testing device comprises a plurality of said sensors, each of said sensors being configured to measure a different parameter of the patient.

8. A system for calculating and displaying a percentile impairment value for a patient, comprising:
a testing device having one or more sensors, each of said sensors configured to measure a parameter of the patient;
a conversion computer connected to the testing device, configured to receive at least one measured parameter value of the patient from at least one of said sensors, having a memory and having stored in said memory at least one algorithm for calculating a percentile impairment score from said measured parameter value of said patient;
a display connected to the conversion computer and configured to receive output from the computer and displaying said output;
an algorithm database connected to the conversion computer, said algorithm database having a memory and stored in said memory at least one library algorithm for calculating a percentile impairment score from a measured parameter value of a patient, wherein the conversion computer can copy one or more library algorithms for calculating a percentile impairment score from a measured parameter value of a patient and store said library algorithm in its memory;
a patient data database connected to the conversion computer, said patient data database having a memory, wherein the patient data database is configured to receive measured parameter values from the conversion computer and store said values in the memory of the patient data database; and
an algorithm generator connected to the patient data database and the algorithm database, wherein the algorithm generator is configured to receive patient data from the patient data database, generate algorithms for calculating a percentile impairment score from a measured parameter value of a patient and store said algorithms as library algorithms in the memory of the algorithm database, wherein the algorithm generator generates the algorithms based on at least one piece of patient data received from the patient data database.

9. The system of claim 8, wherein the algorithm database, the patient data database and the algorithm generator are installed on the same computer host.

10. The system of claim 8, wherein the algorithm database, the patient data database and the algorithm generator are cloud computing services.

11. A gait trainer system comprising:
a motorized treadmill;
at least one sensor configured to measure at least one parameter of a user of said motorized treadmill;
a computer configured to receive at least one parameter measured by said at least one sensor and having a memory, said memory storing at least one algorithm for calculating a percentile impairment score from said at least one parameter, wherein the computer is configured to perform said at least one algorithm;
a display configured to display the percentile impairment score calculated by said computer;
a communication module connected to said computer and configured to transmit information from said computer and receive information for said computer;
an algorithm database storing at least one algorithm for calculating a percentile impairment score from at least one parameter and configured to transmit at least one algorithm for calculating a percentile impairment score from at least one parameter to said communication module;
a patient data database storing at least one parameter of at least one patient and configured to receive at least one parameter of at least one patient from said communication module; and
an algorithm generator configured to generate at least one algorithm for calculating a percentile impairment score from at least one parameter and store at least one algorithm for calculating a percentile impairment score from at least one parameter in the algorithm database, wherein the algorithm generator generates said at least one algorithm for calculating a percentile impairment score from at least one parameter based on at least one parameter stored in the patient data database.

10. The system of claim 9, wherein the algorithm database, the patient data database and the algorithm generator are installed on the same computer host.

11. The system of claim 9, wherein the algorithm database, the patient data database and the algorithm generator are cloud computing services.

12. A method of calculating and displaying a percentile impairment score for a patient, comprising:
measuring at least one parameter of the patient using a testing device;
transmitting at least one parameter of the patient to a patient data database;
calculating at least one statistical value based on parameters of at least two patients previously stored in said patient data database;
calculating a percentile impairment score by comparing the at least one parameter of the patient with the at least one statistical value; and
displaying said percentile impairment score.
